(19) United States
(12) Patent Application Publication
(10) Pub. No.: US 2005/0176370 A1
(43) Pub. Date: Aug. 11, 2005

(54) Information exchanging

(76) Inventors: Brendan T. McSheffrey, Newton, MA (US); Kevin Gulley, Newton, MA (US); Christopher Valentine, Marshfield, MA (US)

Correspondence Address: FISH & RICHARDSON PC, 225 FRANKLIN ST, BOSTON, MA, 02110, US

(21) Appl. No.: 10/763,729

(22) Filed: Jan. 23, 2004

(51) Int. Cl. H04Q 7/20

(52) U.S. Cl. 455/41.2; 370/338; 455/466

(57) ABSTRACT

A method includes receiving data in a handheld wireless transceiver from a wireless device that identifies a trade show exhibitor to a trade show attendee, receiving a selection from the trade show attendee in the handheld wireless transceiver based on the received trade show exhibitor identification data, and sending data representing the selection to a wireless mesh network repeater.

### TECHNICAL FIELD

This invention relates to trade shows, conferences, and expositions, and, more particularly, to exchanging information among trade show attendees and exhibitors.

### BACKGROUND

Attendees at conferences and trade shows usually wear admission badges that present the attendee's name and business to conference and trade show exhibitors that are typically located in booths distributed throughout the trade show. As the attendees visit booths, they sometimes accept literature and hand out business cards so that they can be contacted by particular exhibitors after the trade show. At some trade shows, the badges worn by the attendees include a magnetic strip that stores the attendees contact information (e.g., attendee name, business address, etc.). To provide contact information to an exhibitor, the attendee temporarily hands over his or her badge to the exhibitor and it is “swiped” through a magnetic strip reader that collects the stored contact information. By using the badge to exchange contact information, the attendee does not need to carry a large quantity of business cards for distributing at the trade show. However, in the course of attending a trade show for one or more days, an attendee may become fatigued from numerous conversations with exhibitors and overloaded with their information. Such information overload and fatigue can cause the attendee to become disinterested in engaging more and more exhibitors while moving about the trade show floor and important literature and contact information may be loss or not exchanged.

### SUMMARY

According to one aspect of the invention, a method includes: receiving data in a handheld wireless transceiver from a wireless device that identifies a trade show exhibitor to a trade show attendee, receiving a selection from the trade show attendee in the handheld wireless transceiver based on the received trade show exhibitor identification data, and sending data representing the selection to a wireless mesh network repeater.

Preferred embodiments of this aspect of the invention may include one or more of the following additional features. Data representing the identity of the handheld wireless transceiver may be sent to the wireless mesh network repeater. The data identifying the trade show exhibitor may be received by the wireless device from the wireless mesh network repeater. The wireless device may include a radio frequency (RF) tag. The handheld wireless transceiver includes an RF reader. The selection may indicate to provide the trade show exhibitor with the contact information of the trade show attendee. The selection may indicate to identify the trade show exhibitor in a list.

According to another aspect of the invention, a method includes sending data to a handheld wireless transceiver from a wireless device that identifies a trade show exhibitor to a trade show attendee, and receiving data at a wireless mesh network repeater that represents a selection made by the trade show attendee in the handheld wireless transceiver.

Preferred embodiments of this aspect of the invention may include one or more of the following additional features. Data may be received at the wireless mesh network repeater that identifies the handheld wireless transceiver. The data identifying the trade show exhibitor may be received by the wireless device from the wireless mesh network repeater. The wireless device may include a radio frequency (RF) tag. The handheld wireless transceiver may include an RF reader. The selection may indicate to provide the trade show exhibitor with the contact information of the trade show attendee. The selection may indicate to identify the trade show exhibitor in a list.

According to another aspect of the invention, a trade show information exchange system includes a handheld wireless transceiver capable of, receiving data from a wireless device that identifies a trade show exhibitor to a trade show attendee, receiving a selection from the trade show attendee based on the received exhibitor identification data, and sending data representing the selection to a wireless mesh network repeater.

Preferred embodiments of this aspect of the invention may include one or more of the following additional features. The handheld wireless transceiver may be further capable of sending data representing the identity of the handheld wireless transceiver to the wireless mesh network repeater. The data identifying the trade show exhibitor may be received by the wireless device from the wireless mesh network repeater. The wireless device may include a radio frequency (RF) tag. The handheld wireless transceiver may include an RF reader. The selection may indicate to provide the trade show exhibitor with the contact information of the trade show attendee. The selection may indicate to identify the trade show exhibitor in a list.

According to another aspect of the invention, a trade show information exchange system includes a wireless device capable of, receiving data from a wireless mesh network repeater that identifies a trade show exhibitor, and sending data to a handheld wireless transceiver that identifies the trade show exhibitor to a trade show attendee.

Preferred embodiments of this aspect of the invention may include one or more of the following additional features. The wireless device may include a radio frequency (RF) tag. The handheld wireless transceiver may include an RF reader.

According to another aspect of the invention, a computer program product, tangibly embodied in an information carrier, for exchanging trade show information, the computer program product being operable to cause a handheld wireless transceiver to receive data from a wireless device that identifies a trade show exhibitor to a trade show attendee, receive a selection from the trade show attendee based on the received exhibitor identification data, and send data representing the selection to a wireless mesh network repeater.

Preferred embodiments of this aspect of the invention may include one or more of the following additional features. Data representing the identity of the handheld wireless transceiver may be sent to the wireless mesh network repeater. The data identifying the trade show exhibitor may be received by the wireless device from the wireless mesh network repeater.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram depicting attendees and exhibitors at a trade show.

FIG. 2 is a block diagram depicting attendees visiting exhibitor booths at a trade show.

FIG. 3 is a block diagram depicting data transferring among a trade show attendee, a trade show exhibitor, and a wireless mesh network repeater.

FIG. 4 is a block diagram depicting wireless mesh network repeaters distributed throughout a trade show floor.

FIG. 5 is a block diagram depicting a wireless signal control site.

FIG. 6 is a graphical user interface (GUI) including trade show information.

FIG. 7 is a flow chart of a portion of a transceiver controller.

### DETAILED DESCRIPTION

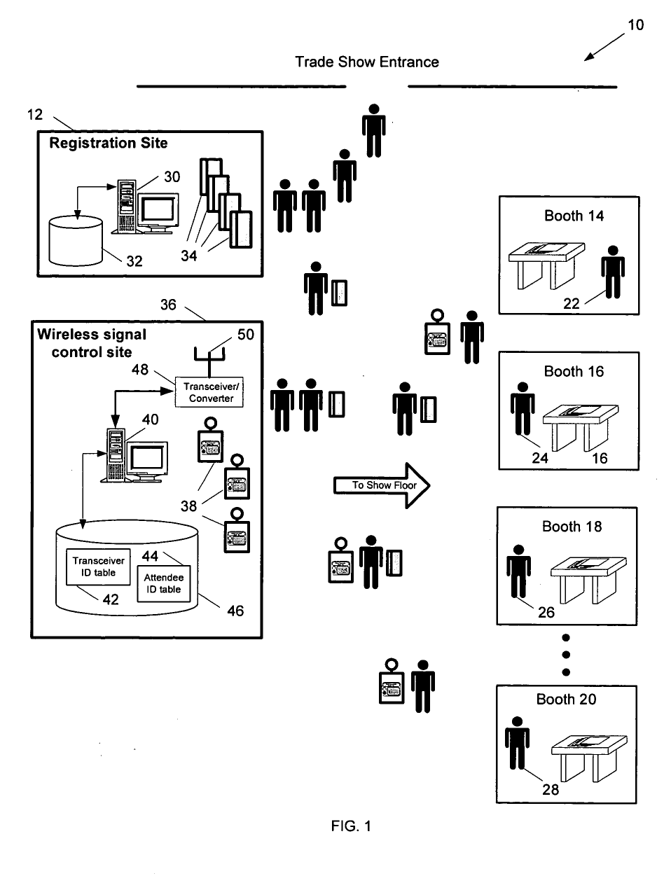

Referring to FIG. 1, in one embodiment, a trade show 10 includes a registration site 12 and a number of exhibitor booths 14-20 that are used by exhibitors 22-28 to attract the attention of trade show attendees. As each attendee enters the trade show 10, the attendee stops by the registration site 12 to gain admission into the trade show by, for example, paying an entrance fee, if not previously paid. Along with granting admission, while at the registration site 12, attendees provide information that is collected. In this example, the registration site 12 includes a computer system 30 that is used to enter information associated with each entering attendee such as contact information (e.g., attendee name, business mailing address, employment position, etc.). Typically, the information is entered into a table, database, or other similar data structure, which is stored in a storage device 32 (e.g., hard drive, CD-ROM, etc.) that is in communication with the computer system 30. Also, each attendee may be requested or asked to answer a questionnaire to provide the organizers of the trade show with additional information such as what is the attendee's primary purpose for attending the trade show 10 and what information the attendee hopes to gain by attending.

The registration site 12 also offers a badge 34 to each attendee that includes, for example, a magnetic strip that is loaded by the computer system 30 with the contact information provided by the attendee. Along with contact information, other information such as details associated with the attendee (e.g., attendee's salary, whether the attendee is a company decision-maker, etc.) or the attendee's company (e.g., company size, location, major products or services, etc,) can be collected and stored on the badge 34. Alternatively, if an attendee has pre-registered through the mail or through a computer network (e.g., the Internet), a badge can be loaded with contact information before the attendee arrives at the trade show 10. By wearing the badge 34 while progressing through the trade show 10 and engaging exhibitors, the attendee can temporarily hand his or her badge to exhibitors for them to collect the contact information stored in the badge. Typically, each of the exhibitor booths 14-20 includes a magnetic strip reader that is capable of reading the contact information stored in each badge.

The trade show 10 also includes a wireless signal control site 36 that provides interested attendees with handheld wireless transceivers 38 that are capable of wirelessly sending and receiving information. Similar to the badges 34, each handheld wireless transceiver 38 is used for exchanging information among the trade show attendees and the trade show exhibitors. Also, while the wireless transceivers 38 are referred to as handheld, the handheld wireless transceivers may be also be worn by the attendees (e.g., worn around the neck), clipped to the attendee's clothing, carried in a container (e.g., briefcase), or accompany the attendee in another similar manner. Prior to providing a handheld wireless transceiver to an attendee, identification data (e.g., an identification number, etc.) unique to the particular handheld wireless transceiver is entered into a computer system 40 located at the wireless signal control site 36. Along with entering data that uniquely identifies the handheld wireless transceiver, data is also entered into the computer 40, or provided from computer system 30 (e.g., through a local area network LAN, etc.), that identifies the particular trade show attendee being provided the handheld wireless transceiver. Typically, this data is stored in respective tables 42, 44, or other similar data structures (e.g., database, data file, etc.), in a storage device 46 (e.g., hard drive, CD-ROM, etc.) that is in communication with the computer system 40.

The computer system 40 located at the wireless signal control site 36 is also in communication with a transceiver/converter 48 that receives and transmits wireless signals through an antenna 50 or other similar device (e.g., laser, photo-detector, acoustic transducer, etc.) dependent upon the wireless technology implemented at the trade show 10. For example, by receiving wireless signals from the handheld wireless transceivers 38 being carried by the trade show attendees, the transceiver/converter 48 can pass information associated with the trade show attendees, the trade show exhibitors, and the trade show to the computer system 40 for collection and processing.

In contrast to attendees using badges, which need to be handed to exhibitor personnel for swiping, by carrying or wearing one of the handheld wireless transceiver 38 while progressing though the exhibitor booths 14-20 at the trade show 10, the attendee can collect information from an exhibitor of interest without directing engaging the exhibitor personnel stationed at the exhibitor booth. For example, an attendee with a handheld wireless transceiver may be interested in collecting information from the exhibitor located in booth 18 without interfacing with the exhibitor personnel 26 at the booth. By using the handheld wireless transceiver, the attendee can initiate transmission of a wireless signal to the wireless signal control site 36 to request information associated with the exhibitor. So, if an attendee becomes fatigued at the trade show 10, he or she does not need to spend energy and time to interface with exhibitor personnel in order to collect information from them. Also, if the attendee has a timid personality, a wirelessly initiated information request can be used to collect information without directly interfacing. Furthermore, if a particular booth is crowded with numerous people, or if the exhibitor personnel are currently away from a booth (e.g., on a lunch break), the attendee can use the handheld wireless transceiver to request information and not have to wait for the crowd to disburse or the exhibitor personnel to return.

Along with using the handheld wireless transceiver 38 to request information from the exhibit booths 14-20, the trade show attendee can use the handheld wireless transceiver to grant particular exhibitors permission to receive the attendee's contact information, again without directly interfacing with the exhibitor personnel. For example, after looking over material presented in the exhibitor booth 18, an attendee may be interested in having the exhibitor contact (e.g., place a telephone call, send an electronic mail (email) message, etc.) the attendee at a later time after the trade show. To provide his or her contact information (e.g., business telephone number, email address, etc.) to the exhibitor, the attendee initiates transmission of a wireless signal from the handheld wireless transceiver that is received by the antenna 50 at wireless signal control site 36 and the granting of the permission is collected by the computer system 40. By controlling the flow of information to the exhibitors, the attendees determine which of the exhibitors receives their contact information along with determining which exhibitor they would like to collect information. By placing the control of the information flow with the trade show attendees, the exhibitors are blocked from passively collecting contact information associated with attendees without being granted permission by the attendee to receive such information.

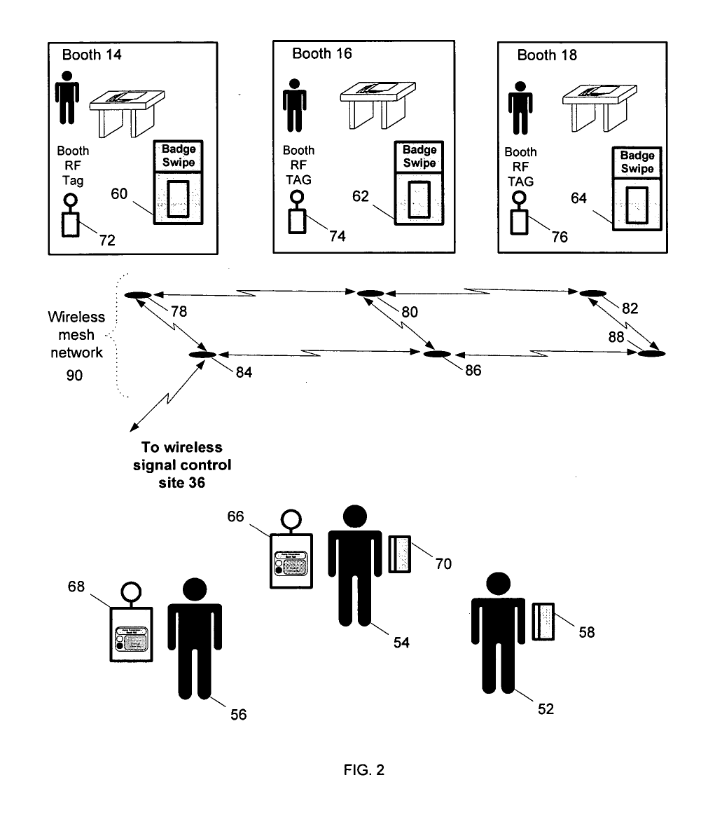

Referring to FIG. 2, in this particular example, three trade show attendees 52-56 have chosen to carry and use different equipment for collecting and exchanging information with exhibitors at the trade show 10. For example, attendee 52 has selected to carry or wear one of the badges 58 that include a magnetic strip that stores the attendee's contact information. To provide his or her contact information, for example, to the exhibitor personnel stationed at exhibitor booth 14, attendee 52 directly engages the exhibitor personnel and temporarily hands over his or her badge 58 so that the exhibitor can collect their contact information. In this example, to collect the contact information the exhibitor personnel uses a badge reader 60 that is located in the exhibitor booth 14 and reads the contact information stored in the magnetic strip of the badge. After “swiping” the badge 58 through the badge reader 60, typically the exhibitor personnel returns the badge to the attendee 52 so that the badge can by swiped in other badge readers 62, 64 located in other exhibitor booths 16, 18 to provide the attendee's contact information with other exhibitors.

In this example, attendees 54 and 56 have selected to carry or wear a handheld wireless transceivers 66, 68 to collect information from the exhibitors and to request that their contact information be provided to one or more exhibitors of their choice. By using the handheld wireless transceivers 66, 68 the attendees 54, 56 can collect information and grant permission to their contact information without directly engaging the exhibitor personnel at the booths 14, 16, and 18. Also, in this example, attendee 54 has also chosen to carry a badge 70 so that if he or she does directly engage an exhibitor, the attendee can hand over the badge so that the exhibitor can collect the attendee's contact information. By populating the trade show attendees with both badges and wireless tags, both the exhibitors and the trade show organizers can track and produce statistics that convey the number of attendees that passively interacted with the exhibit booths, by using handheld wireless transceivers, and the number of attendees that directly engaged exhibitor personnel and handed over their badges, which could be used to measure the effectiveness of the exhibitor personnel.

As each of the attendees 54, 56 using handheld wireless transceivers 66, 68 comes in close proximity with one of the exhibitor booths 14-18, a wireless link is established with a wireless device such as respective radio frequency (RF) transponder 72-76, which are each referred to as RF tags, and are respectively located in the booths. For example, as attendee 56 comes in close proximity of booth 14, the handheld wireless transceiver 70 carried by the attendee establishes a wireless link with RF tag 72. Similarly, as attendee 56 comes in close proximity with booth 16 or booth 18, respective RF tags 74 and 76 establish wireless links with the attendee's handheld wireless transceiver 70. To establish a wireless link, each handheld wireless transceiver includes a radio frequency (RF) source, such as an RF reader, that propagates RF energy to the RF tag. The RF tag, which is tuned to resonate at the RF energy frequency, receives the energy and uses the received energy to transmit a wireless signal to the handheld wireless transceiver and establish the wireless link.

By establishing the wireless link, data representing information associated with the exhibitor (e.g., identification information) is passed from the RF tag to the handheld wireless transceiver. Using the received data the attendee can decide whether to request information from the exhibitor, or grant the exhibitor permission to receive the attendee's contact information, or to indicate other similar decisions. For example, after receiving exhibitor information from the RF tag 72 in booth 14, the attendee 54 may decide to request information from the exhibitor using booth 14. Upon making the decision, the attendee 54 can use the handheld wireless transceiver 66 to send a wireless signal back to the wireless signal control site 36 so that the exhibitor information is provided to the attendee. By using a wireless signal to initiate the request, the attendee does not have to take notes, remember which exhibitors were interesting, or pick up material at the exhibitor's booth.

Upon initiating the wireless signal from either of the handheld wireless transceivers 66, 68, the signal is received by one or more nearby wireless repeaters 78-88 that together produce a wireless mesh network 90. By receiving the wireless signal on one or more of the wireless repeaters 78-88, the signal can then be passed to other wireless repeaters included in the wireless mesh network in order to relay the data included in the wireless signal to the wireless signal control site 36 for reception and processing. Also, by distributing the wireless repeaters 78-88 throughout the trade show floor, the wireless signals sent from the handheld wireless transceivers 66, 68 do not need relatively large power levels as needed to propagate directly from the handheld wireless transceiver to the wireless signal control site 36. In this embodiment, each of the wireless repeaters 78-88 receives and transmits electromagnetic signals (e.g., radio frequency (RF) signals). However, in other embodiments other wireless techniques or combinations of wireless techniques are implemented to pass signals among the repeaters and the wireless signal control site 36. For example, infrared technology, laser technology, acoustic technology, or other types of wireless technology may be implemented individually or in combination into the wireless mesh network 90.

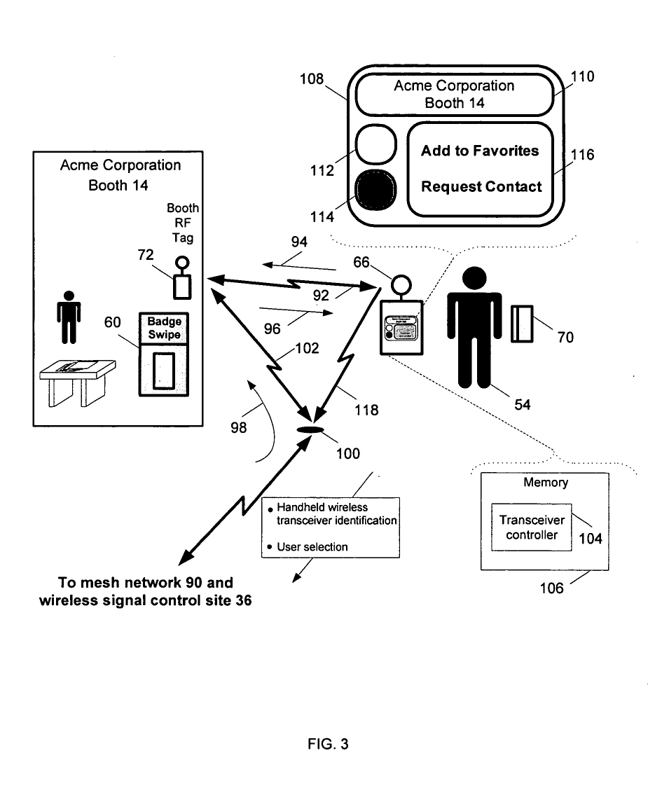

Referring to FIG. 3, in this embodiment as attendee 54 comes within close proximity to exhibit booth 14, a wireless link 92 is established between the RF tag 72 and the handheld wireless transceiver 66 being carried by the attendee. In this example, the wireless link 92 is established by the handheld wireless transceiver 66 transmitting an RF signal 94 at a particular frequency (e.g., 13.56 Mega Hertz) such that when the RF signal is received by the RF tag 72, circuitry included in the tag tuned to the RF signal frequency resonates, and an RF response signal 96 is produced and transmitted to the handheld wireless transceiver 66, which includes circuitry for receiving the response signal.

The RF signal 96 transmitted to the handheld wireless transceiver 66 includes data that represents information associated with the exhibitor and the booth 14 where the RF tag 72 is positioned. For example, data that identifies the exhibitor (e.g., exhibitor name, a unique number assigned to the exhibitor, etc.) and the exhibitor's booth (e.g., booth number, booth location on the trade show floor, etc.) is included in the RF signal 96. In some embodiments, this identification data is stored in the RF tag 72 prior to it being positioned in the exhibitor booth 14. However, in other embodiments, the data is stored in the RF tag 72 after it is positioned in the booth. For example, data that represents the exhibitor's identity and the number assigned to the booth is entered into the computer system 40 located at the wireless signal control site 36. The data is then transmitted in a wireless signal from the wireless signal control site 36, through the wireless mesh network 90, and delivered to the RF tag 72. In this particular example, the data is sent on a wireless signal 98 through the wireless mesh network 90 and is received by a repeater 100 that is included in the wireless mesh network 90. The repeater then relays the wireless signal 98 over a wireless link 102 that is established between the RF tag 72 and the repeater 100. Upon receiving the signal 98, the RF tag 72 decodes the identification data included in the signal and stores the data in a memory device (e.g., EPROM chip, EEPROM chip, etc.) included in the tag.

Upon the handheld wireless transceiver 66 receiving the RF response signal 96, the signal is decoded to retrieve the data that represents the identity of the exhibitor and the booth being used by the exhibitor. In this embodiment, transmitting of the wireless signal 94, receiving of the wireless signal 96, decoding data, and other processes, are provided by a transceiver controller 104, which is executed in the handheld wireless transceiver 66. In this embodiment, the transceiver controller 104 is stored in a memory 106 (e.g., random access memory (RAM), read-only memory (ROM), static RAM (SRAM), dynamic RAM (DRAM), etc.) that is included in the handheld wireless transceiver. Although, in some embodiments, the transceiver controller 104 is loaded into the memory 106 from a storage device (e.g., a hard drive, CD-ROM, etc.) that is in communication with the handheld wireless transceiver 66.

After decoding the identification information from the signal 96, the transceiver controller 104 presents the information in a graphical user interface (GUI) 108 so that the attendee 54 can determine which exhibitor booth is currently being linked with wireless link 92. In this example, a field 110 in the GUI 108 presents the identity of the particular exhibitor (e.g., Acme Corporation) and a number (e.g., Booth 14) assigned to the particular booth where the exhibitor is located. Textual information is used to present the identity of the exhibitor and the exhibitor's booth. However, in other embodiments, the GUI 108 presents other types of content with or without the textual information to identify the exhibitor. For example trademarks, logo, or other graphical identifiers may be presented in the GUI 108. Also, video content (e.g., advertisements, product demonstrations, etc.) may be presented with or without audio content that is associated with the exhibitor and is decoded by the transceiver controller 104 from the wireless signal 96.

The GUI 108 also includes two selectors 112, 114 that are used by the attendee to enter selections based on the identification information being presented in field 110. In this embodiment, each of the selectors 112, 114 respectively correspond to text presented in another field 116 included in the GUI 108, although as mentioned above, other types of content (e.g., trademarks, video, audio, etc.) may be presented to the attendee to assist with making one or more selections. In this embodiment, each of the selectors 112, 114 are touch-sensitive and can detect when they are respectively pressed by the attendee, however, in other embodiments other sensing techniques such as light obstruction detecting, body heat detecting, etc. are implemented.

Based on the attendee's interest, either or both of the selectors 112, 114 may be selected. Here, selector 112 is selected by the attendee 54 to indicate that he or she is interested including the exhibitor presented in the field 110 (e.g., Acme Corporation) in a list of “favorite” exhibitors specific to the attendee. For example, the attendee 54 may be interested in all exhibitors at the trade show 10 that are producing a particular style of luxury car. So, for each instance in which the attendee establishes a wireless link with a booth being used by a luxury car manufacturer, the attendee can select to add each manufacturer to his or her running list of “favorites”. To have the exhibitor added to the list of “favorites”, when the attendee 54 presses selector 112, transmission of a wireless signal 118 is initiated from the handheld wireless transceiver 66 that is eventually received at the wireless signal control site 36 where the list is stored on computer 40. The wireless signal 118 includes data that identifies the user selection to add the exhibitor to his or her list of “favorites”. The wireless signal 118 also includes data that identifies the particular handheld wireless transceiver 66 so that the specific attendee that initiated the signal can be determined at the wireless signal control site 36. In this embodiment, the transmitted wireless signal 118 is received by the wireless repeater 100 in close proximity with the handheld wireless transceiver 66. However, in some embodiments, the RF tag 72 includes electronic circuitry so that the wireless signal 118 is received by the RF tag and is then transmitted to the wireless repeater 100 for transmission through the wireless mesh network 90 to the wireless signal control site 36.

Along with selecting to add the exhibitor to a list of “favorite” exhibitors, in this embodiment, the attendee can also select to request that the exhibitor contact the attendee 54 after the trade show. By pressing the selector 114, transmission of a wireless signal similar to wireless signal 118 is initiated from the handheld wireless transceiver 66, through the wireless mesh network 90, and to the wireless signal control site 36. By pressing selector 114, the attendee grants permission for the exhibitor to receive the attendees contact information from the trade show organizers. Thus, unless the attendee presses the selector 114, or hands over a badge for the exhibitor to swipe through the badge reader 60, the attendee's contact information is not provided to the exhibitors and is held in confidence by the trade show organizers.

In these embodiments, the wireless signal 118 includes data that represents which selection (e.g., “Add to Favorites”, “Request Contact”) has been made by the attendee, along with data that represents which handheld wireless transceiver 66 initiated transmission of the signal. However, in other embodiments, other information is included in the wireless signal 118. For example, the location of the attendee on the trade show floor may be included from data provided by a global position system (GPS) receiver included in the handheld wireless transceiver 66. Alternatively, the position of the attendee may be inserted into the wireless signal 118 by the first wireless repeater in the wireless mesh 90 to receive the signal after being transmitted from the handheld wireless transceiver 66. In this example, since wireless repeater 100, which is located near to booth 14, is the first member of the wireless mesh network 90 to receive the wireless signal 118, it may insert data into the wireless signal that identifies the wireless repeater so that the wireless signal control site 36 can approximately determine where the attendee is located. Also, in some embodiments each of the wireless signals is encoded and/or encrypted to provide secure data transmission and to reduce interference among the wireless transmissions. Besides the attendee selecting the “Add to Favorites” selection and the “Request Contact” selection, other attendee selections may be presented to the attendee. For example, a selection may be presented for the attendee to request information (e.g., product portfolio, company prospectus, etc.) from the exhibitor, in which permission to some or all of the attendee's contact information is granted to the exhibitor. In this embodiment, the handheld wireless transceiver 66 is used by the attendee and includes circuitry for reading the information stored in the RF tags along with circuitry for establishing wireless links, however, in other embodiments, a cellular telephone, a personal digital assistant (PDA) with wireless transmission and reception circuitry, or other similar wireless signaling device can be used by the attendee to execute the operations of the transceiver controller 104.

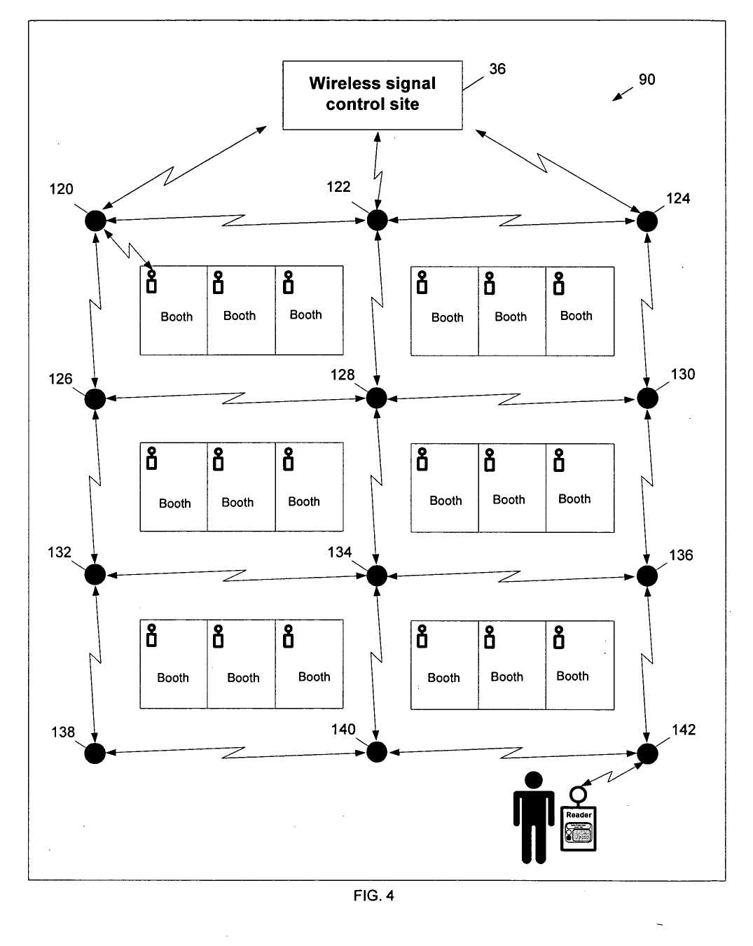

Referring to FIG. 4, for demonstrative purposes in this embodiment the wireless mesh network 90 includes, for example, twelve wireless repeaters 120-142 are distributed in a grid pattern throughout the trade show floor. However, typically the wireless mesh network 90 includes more wireless repeaters. For example in some embodiments, one or more wireless repeaters are located proximate to each of the exhibitor booths included in the trade show. Also, as shown in FIG. 3, in this embodiment each of the wireless repeaters 120-142 are floor-mounted, however, in other embodiments, some or all of the wireless repeaters are ceiling-mounted and/or wall-mounted. Besides using a grid system, the wireless repeaters may be distributed in other geographical shapes (e.g., a spiral distribution, concentric circle distribution etc.) to provide different resolving granularity for localizing the handheld wireless transceiver that has initiated a wireless signal transmission to the wireless signal control site 36.

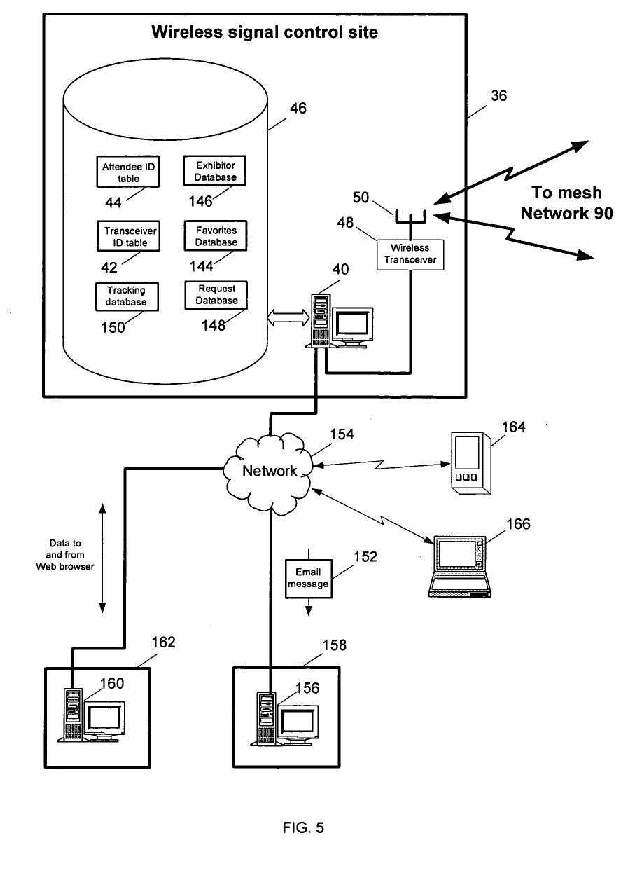

Referring to FIG. 5, after the wireless signals are transmitted by the handheld wireless transceivers, and passed through the wireless mesh network 90, the signals are received by the wireless signal control site 36. In this embodiment, the wireless signals are received by the antenna 50 located at the reception site 36 and are passed to the transceiver/converter 48. The transceiver/converter 48 decodes the wireless signals and decrypts the signals to remove any previously applied encryption scheme. The transceiver/converter 48 also converts and/or conditions the signals into digital signals that are sent to the computer system 40 for processing and for storing the information included in the wireless signals. For example, some received wireless signals include data that identify the particular handheld wireless transceiver that initiated the wireless signal along with data that identifies a particular exhibitor to be added to a list of favorites exhibitor specific to the attendee using the handheld wireless transceiver. Upon receiving the data, the computer system 40 respectively stores data identifying the exhibitor in a “Favorites” database 144 in the storage device 46. Also, by using the data that identifies the particular handheld wireless transceiver that sent the wireless signal, along with the data in tables 42, 44, the particular attendee associated with the list of “Favorites” is identified along with which particular list that should be accessed to add the data identifying the exhibitor. By identifying the exhibitor in a list of “Favorites”, information (e.g., advertisements, product specifications, white papers, web sites, etc.) associated with each “favorite” exhibitor can be retrieved from an exhibitor database 146 and sent, along with the list itself, to the particular attendee that selected to receive information about the exhibitor.

Wireless signals may also include, along with data identifying the handheld wireless device that sent the signal, data representing an attendee selection to request contact from a particular exhibitor. In this embodiment, the request is stored in a request database 148 along with data that represents the attendee making the request, which is typically provided by the attendee ID table 44. Since both the attendee requesting contact is identified along with the exhibitor of interest, as provided by the request, the particular exhibitor is granted permission to be given the attendee's contact information.

Other data associated with the received wireless signals is also stored in the store device 46. For example, a tracking database 150 stores data from each received wireless signal so that the location of each attendee that initiated the signal with a handheld wireless transceiver is tracked and time-stamped. For example, an attendee standing near one booth may send a wireless signal with his or her handheld wireless transceiver at one time that indicates the location of the attendee and the time the transmission was initiated. Then, at a later time the attendee may initiate a wireless transmission from a location near another exhibitor booth that is received by a different wireless repeater in the wireless mesh network 90. This second wireless signal propagates though the wireless mesh network 90 and is received at the wireless signal control site 36 and provides data that is stored in the tracking database 150 to retain the location of the attendee at the later time.

After the trade show has ended and all the data has been stored, the computer system 40 can retrieve portions of the stored information, along with other information, for sending to the attendees. For example, the computer system 40 can execute processes to send each respective attendee their list of favorite exhibitors that was collected during their time at the trade show. Additionally, along with the list of favorites, the computer system 40 can be used to collect and respectively send to the attendees website addresses (e.g., Uniform Resource Locator (URL) addresses, etc.), advertisements, white papers, journal articles, and other informational content associated with each favorite list entry. In one embodiment, once collected, the list of favorites and other information is attached to an electronic mail (email) message 152 that is sent from the computer system 40, through a network 154 (e.g., the Internet, a local area network (LAN), a wide area network (WAN), etc.) and delivered to an email address provided by the attendee. For example, one attendee may provides an email address when he or she registered so that they are able to receive the email message 152 at a computer system 156 located at their business 158. Additionally, the attendee may provide other email addresses for viewing the list of favorites on a computer system at the attendee's home.

In this embodiment, the collected information content associated with each favorite list entry is placed in a webpage that is developed with the computer system 40 so that the attendee can access the website to view and retrieve the collected information. For example, after leaving the trade show 10, an attendee can access a website that is associated with the trade show organizers from a computer system 160 located at his or her home or place of business 162. Once the website is accessed, the attendee can navigate through the website to the particular webpage or pages that contains the collected information associated with each of the entries that the attendee selected for inclusion in his or her list of favorite exhibitors. Furthermore, in some arrangements, to access and be presented the webpage or webpages, the attendee enters a password or uses another security technique to gain access to the collected information. Additionally, the content of the webpage or pages may be encrypted prior to being sent from the computer system 40 through the network 154 for delivery and decrypting by the computer system 160 at the attendee's home or place of business 162. By collecting and presenting such information in an email message or on one or more webpages, trade show attendees do not need to collect literature, papers, and other material from each exhibitor that the attendee finds interesting. Also, by electronically providing the information to the attendees, the exhibitors can bring less material to the trade show for distributing to attendees. By reducing the time and burden to collect information from exhibitors, an attendee can use the conserved time for having longer and more in-depth discussions with the exhibitors along with visiting more exhibitor booths. In this particular embodiment the computer systems 156 and 160 are used to receive emails or interact with websites that include the attendees list of favorites and other information. However, in other embodiments, a PDA 164, a laptop 166, or similar digital device such as a cellular telephone is used to wirelessly, or by hardwire, connect to the network 154 and receive the email messages or access the websites.

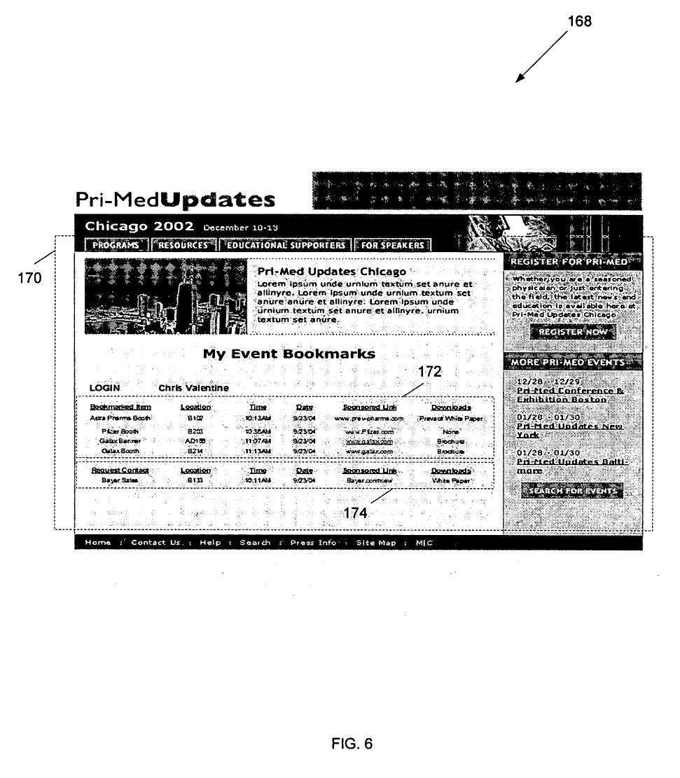

Referring to FIG. 6, an exemplary webpage 168 is shown that includes a graphical user interface (GUI) 170 that presents the list 172 of favorite exhibitors that were collected by a particular trade show attendee (e.g., Chris Valentine). The GUI 170 also includes a list 174 of exhibitors that the attendee has granted permission to receive his contact information from the trade show organizers so that the exhibitor (e.g., Bayer Sales) can contact the attendee at a later time for additional discussions and information exchanging. In this embodiment, each of the entries in the list 172 of favorites and the list 174 of contact requests includes the particular location, time, and date in which the attendee either selected to add the exhibitor to the list of favorites or selected to request contact from the exhibitor. By presenting this location and temporal information in the GUI 170, the attendee can better recall the exhibitor that he selected based on his location and the time of day that the selection was made. In this embodiment, the each list 172, 174 also includes a URL website or other computer network contact information (e.g., email address) associate with each list entry so the attendee can relatively quickly link and view a website associated with any list entry. Additionally, the lists 172, 174 include a list of information respectively associated with each list entry that can be downloaded. For example, some of the list entries have white papers or brochures that can be downloaded while other list entries did not provide downloadable material for inclusion in the GUI 170.

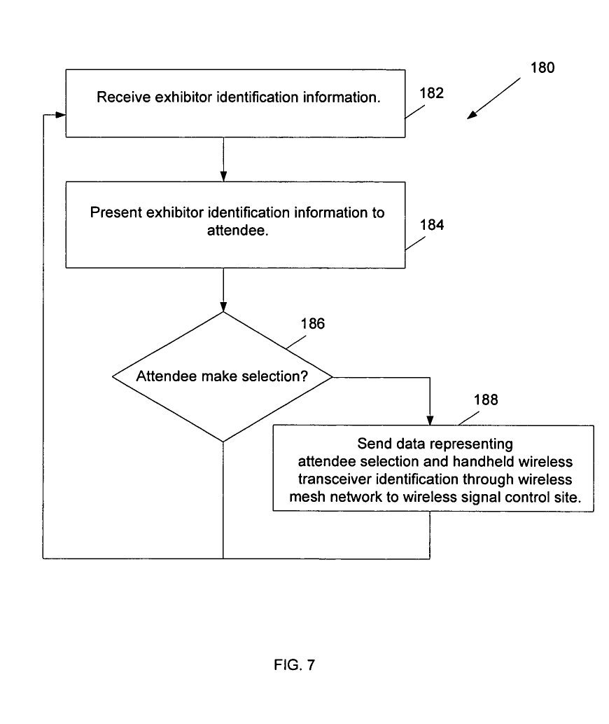

Referring to FIG. 7, a portion of a transceiver controller 180, such as the transceiver controller 104 stored and executed in the handheld wireless transceiver 66 includes receiving 182 exhibitor identification information. In one embodiment, the received identification information includes data that identifies the exhibitor and data (e.g., a uniquely assigned number) that represents a particular booth that the exhibitor is using at a trade show. After the identification information is received, the transceiver controller 180 presents 184 the exhibitor identification information to the attendee that is carrying or wearing the handheld wireless transceiver. In some embodiments, the identification information is presented in a GUI with a textual format so that the attendee can determine which particular exhibitor booth the handheld wireless transceiver has established a wireless link. Furthermore, by viewing this identification information along with other material (e.g., demonstrations, posters, etc.) presented in the exhibitor booth, the attendee can determine whether he or she is interested in collecting information about the exhibitor without having to engage exhibitor personnel stationed in the booth or whether to grant the exhibitor permission to receive his or her contact information for contacting the attendee after the trade show.

The transceiver controller 180 also includes determining 186 whether the attendee has entered a selection into the handheld wireless transceiver. For example, the attendee may enter a selection that represents to have the exhibitor included in a list of favorite exhibitors being collected by the attendee. The attendee may also select to enter a selection that represents to request that the exhibitor be given the attendee's contact information so that the exhibitor can contact the attendee after the trade show. Typically, the attendee makes a selection by pressing a button included in the handheld wireless transceiver or by pressing a touch-sensitive portion of a GUI presented on the transceiver.

If the attendee has entered a selection into the handheld wireless transceiver, the transceiver controller 180 initiates sending 188 a wireless signal that includes data representing the user selection along with data (e.g., a unique number) representing a unique identifier assigned to the handheld wireless transceiver in which the selection was entered. Also, in some embodiments, additional data is included in the wireless signal. For example, data representing the day and time that the attendee selection was entered is included in the wireless signal for later use, e.g., assisting the attendee in remembering the order in which the favorite exhibitors were visited. The wireless signal is transmitted from the handheld wireless transceiver through a wireless mesh network, such as wireless mesh network 90, for delivery to a wireless signal control site for data processing and storing, such as the wireless signal control site 36 (both shown in FIG. 4).

If the attendee has not entered a selection based on the exhibitor information being presented on the handheld wireless transceiver, or after transmission of a wireless signal has been initiated, the transceiver controller 180 returns to receive exhibitor identification information, which may be from the same exhibitor booth or another booth as the attendee progresses about the trade show.

A number of embodiments of the invention have been described. Nevertheless, it will be understood that various modifications may be made without departing from the spirit and scope of the invention. For example, while the wireless mesh network 90 (shown in FIG. 4) is produced with wireless links, in some embodiments, a combination of hardwire technology (e.g., cable line, twisted pair conductors, etc.) and wireless technology (e.g., electromagnetic (EM), infrared (IR), optical, acoustic etc.), may be used to provide communication links among the wireless repeaters 120-142 and the wireless signal control site 36. Also, besides positioning the RF tags in exhibitor booths, the RF tags may be positioned in conference rooms, on signs, banners, podiums and other locations and/or items typically found at a trade show.

The processes described above, such as the transceiver controller 104, can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Accordingly, other embodiments are within the scope of the following claims.

1. A method comprising:
receiving data in a handheld wireless transceiver from a wireless device that identifies a trade show exhibitor to a trade show attendee;
receiving a selection from the trade show attendee in the handheld wireless transceiver based on the received trade show exhibitor identification data; and
sending data representing the selection to a wireless mesh network repeater.

2. The method of claim 1 further comprises:
sending data representing the identity of the handheld wireless transceiver to the wireless mesh network repeater.

3. The method of claim 1, wherein the data identifying the trade show exhibitor is received by the wireless device from the wireless mesh network repeater.

4. The method of claim 1, wherein the wireless device includes a radio frequency (RF) tag.

5. The method of claim 1, wherein the handheld wireless transceiver includes an RF reader.

6. The method of claim 1, wherein the selection indicates to provide the trade show exhibitor with the contact information of the trade show attendee.

7. The method of claim 1, wherein the selection indicates to identify the trade show exhibitor in a list.

8. A method comprising:
sending data to a handheld wireless transceiver from a wireless device that identifies a trade show exhibitor to a trade show attendee; and
receiving data at a wireless mesh network repeater that represents a selection made by the trade show attendee in the handheld wireless transceiver.

9. The method of claim 8 further comprises:
receiving data at the wireless mesh network repeater that identifies the handheld wireless transceiver.

10. The method of claim 8, wherein the data identifying the trade show exhibitor is received by the wireless device from the wireless mesh network repeater.

11. The method of claim 8, wherein the wireless device includes a radio frequency (RF) tag.

12. The method of claim 8, wherein the handheld wireless transceiver includes an RF reader.

13. The method of claim 8, wherein the selection indicates to provide the trade show exhibitor with the contact information of the trade show attendee.

14. The method of claim 8, wherein the selection indicates to identify the trade show exhibitor in a list.

15. A trade show information exchange system comprising:
a handheld wireless transceiver capable of,
receiving data from a wireless device that identifies a trade show exhibitor to a trade show attendee,
receiving a selection from the trade show attendee based on the received exhibitor identification data, and
sending data representing the selection to a wireless mesh network repeater.

16. The trade show information exchange system of claim 15, wherein the handheld wireless transceiver is further capable of,
sending data representing the identity of the handheld wireless transceiver to the wireless mesh network repeater.

17. The trade show information exchange system of claim 15, wherein the data identifying the trade show exhibitor is received by the wireless device from the wireless mesh network repeater.

18. The trade show information exchange system of claim 15, wherein the wireless device includes a radio frequency (RF) tag.

19. The trade show information exchange system of claim 15, wherein the handheld wireless transceiver includes an RF reader.

20. The trade show information exchange system of claim 15, wherein the selection indicates to provide the trade show exhibitor with the contact information of the trade show attendee.

21. The trade show information exchange system of claim 15, wherein the selection indicates to identify the trade show exhibitor in a list.

22. A trade show information exchange system comprising:
a wireless device capable of,
receiving data from a wireless mesh network repeater that identifies a trade show exhibitor, and
sending data to a handheld wireless transceiver that identifies the trade show exhibitor to a trade show attendee.

23. The trade show information exchange system of claim 22, wherein the wireless device includes a radio frequency (RF) tag.

24. The trade show information exchange system of claim 22, wherein the handheld wireless transceiver includes an RF reader.

25. A computer program product, tangibly embodied in an information carrier, for exchanging trade show information, the computer program product being operable to cause a handheld wireless transceiver to:
receive data from a wireless device that identifies a trade show exhibitor to a trade show attendee;
receive a selection from the trade show attendee based on the received exhibitor identification data; and
send data representing the selection to a wireless mesh network repeater.

26. The computer program product of claim 25, being further operable to cause a handheld wireless transceiver to:
send data representing the identity of the handheld wireless transceiver to the wireless mesh network repeater.

27. The computer program product of claim 25, wherein the data identifying the trade show exhibitor is received by the wireless device from the wireless mesh network repeater.
